(19) United States
(12) Patent Application Publication
(10) Pub. No.: US 2026/0132020 A1
(43) Pub. Date: May 14, 2026

(54) MULTIPURPOSE SOLID HYDROGEN STORAGE DEVICE

(71) Applicant: CHINA HYDROGEN ENERGY TECHNOLOGY COMPANY, Beijing (CN)

(72) Inventors: Xiaofeng LIANG, Beijing (CN); Mingqiang ZHOU, Beijing (CN)

(73) Assignee: CHINA HYDROGEN ENERGY TECHNOLOGY COMPANY, Beijing (CN)

(21) Appl. No.: 19/432,940

(22) Filed: Dec. 25, 2025

Related U.S. Application Data
(63) Continuation of application No. PCT/CN2025/133468, filed on Nov. 7, 2025.

(30) Foreign Application Priority Data
Nov. 14, 2024 (CN) 2024116201964

(51) Int. Cl. C01B 3/0084

(52) U.S. Cl. CPC C01B 3/0084

(57) ABSTRACT

The present disclosure discloses a multipurpose solid hydrogen storage device, including: a hydrogen storage device body including hydrogen storage profiles, upper cover plates and lower cover plates, where the upper and lower cover plates are arranged at upper and lower ends of the hydrogen storage profiles respectively, gas chambers and heat conduction water chambers are formed in the hydrogen storage profiles, and the upper cover plates are provided with gas valves communicated with the gas chambers, and water inflow valves and water outflow valves communicated with the heat conduction water chambers. Solid hydrogen storage materials can release massive heat when absorbing hydrogen, the water inflow valves and the water outflow valves, which are communicated with the heat conduction water chambers, are further arranged on the upper cover plates, through which cold water is injected into the heat conduction water chambers, and heat is taken away through the cold water.

### TECHNICAL FIELD

The present disclosure relates to the technical field of hydrogen storage devices, in particular to a multipurpose solid hydrogen storage device.

### BACKGROUND

Solid storage materials, as the name suggests, are fixed materials that can store hydrogen by reversibly absorbing and releasing it. Usually, after absorbing hydrogen, the fixed hydrogen storage materials need to be stored in storage devices. Most of existing solid hydrogen storage devices are fixed or separate. For instance, the Chinese utility model patent with an application number of CN202123269954.7 discloses a hydrogen storage container and a hydrogen storage device, and the Chinese utility model patent with an application number of CN202420104088.0 discloses a solid hydrogen storage material storage bottle. However, the hydrogen storage devices in the above arts are either inconvenient to move or have too small capacity. Moreover, they have low heat conduction performance, greatly affecting hydrogen absorption and release. The sizes, storage spaces, and hydrogen charging and storage manners of the hydrogen storage devices have been fixed, such that the hydrogen storage devices are inconvenient to operate for users.

Therefore, it is necessary to propose a multipurpose solid hydrogen storage device to at least partially solve the problems in the prior art.

### SUMMARY

A series of concepts in simplified forms have been introduced in the summary of the present disclosure, which will be further described in detail in specific implementations. The summary of the present disclosure does not imply an attempt to define key features and necessary technical features of claimed technical solutions, nor does it imply an attempt to determine the scope of protection of the claimed technical solutions.

In order to at least partially solve the above problems, the present disclosure provides a multipurpose solid hydrogen storage device, including a hydrogen storage device body, where the hydrogen storage device body includes hydrogen storage profiles, upper cover plates and lower cover plates, the upper cover plates are arranged at upper ends of the hydrogen storage profiles, the lower cover plates are arranged at lower ends of the hydrogen storage profiles, gas chambers and heat conduction water chambers are formed in the hydrogen storage profiles, the upper cover plates are provided with gas valves communicated with the gas chambers, water inflow valves and water outflow valves, and the water inflow valves and the water outflow valves are communicated with the heat conduction water chambers.

According to the multipurpose solid hydrogen storage device in the embodiment of the present disclosure, the heat conduction water chamber is formed in a middle of the gas chamber, an inner water guide pipe is arranged in the heat conduction water chamber, a water inlet and a water outflow channel are formed in the upper cover plate, the water inlet is located in a middle of the upper cover plate and located above the heat conduction water chamber, the water inflow valve is arranged on the water inlet and connected with an upper end of the inner water guide pipe, and the water outflow channel is located in one side of the water inlet.

According to the multipurpose solid hydrogen storage device in the embodiment of the present disclosure, the water outflow channel includes a first water outlet, a middle water outflow groove, and a second water outlet, the first water outlet is located in one side of the water inlet, the middle water outflow groove is located in the upper cover plate, the second water outlet is located in an upper surface of the upper cover plate, and the water outflow valve is arranged on the second water outlet.

According to the multipurpose solid hydrogen storage device in the embodiment of the present disclosure, a plurality of heat conduction partitions are arranged between the gas chamber and the heat conduction water chamber, the plurality of heat conduction partitions divide the gas chamber into a plurality of sub gas chambers, gas chamber channels are formed between the heat conduction partitions and the upper cover plate, and a sealing ring is arranged between a bottom of the heat conduction water chamber and the lower cover plate.

According to the multipurpose solid hydrogen storage device in the embodiment of the present disclosure, a plurality of first heat conduction fins are arranged on a surface of the heat conduction partition, a plurality of second heat conduction fins are arranged on an inner wall of the gas chamber, and the second heat conduction fin is located between every two adjacent heat conduction partitions.

The multipurpose solid hydrogen storage device in the embodiment of the present disclosure further includes a fixed hydrogen storage seat, a plurality of profile holes are formed in the fixed hydrogen storage seat, and the hydrogen storage profiles are invertedly arranged in the profile holes.

According to the multipurpose solid hydrogen storage device in the embodiment of the present disclosure, a hydrogen channel is formed in the fixed hydrogen storage seat, the gas valve is communicated with the hydrogen channel, a side valve body is arranged on a side wall of the fixed hydrogen storage seat, and the side valve body is communicated with the hydrogen channel.

According to the multipurpose solid hydrogen storage device in the embodiment of the present disclosure, the gas valve is connected with an external gas pipe through an anti-bending module, the anti-bending module includes a first anti-bending cover and a second anti-bending cover, the first anti-bending cover and the second anti-bending cover are mutually engaged on the gas valve and the external gas pipe, a plurality of centralizing mechanisms are arranged in the first anti-bending cover and the second anti-bending cover, and the gas valve and the external gas pipe are fixed by the plurality of centralizing mechanisms respectively.

According to the multipurpose solid hydrogen storage device in the embodiment of the present disclosure, the centralizing mechanism includes a first centralizing assembly and a second centralizing assembly, the first centralizing assembly is arranged in the first anti-bending cover, the second centralizing assembly is arranged in the second anti-bending cover, the first centralizing assembly includes a first C-type centralizing plate, two second C-type centralizing plates and two centralizing frames, the first C-type centralizing plate is arranged in the first anti-bending cover through a plurality of inner rods, the centralizing frames are arranged on an inner wall of the first anti-bending cover, and the two second C-type centralizing plates are arranged between the two centralizing frames.

Compared with the prior art, the present disclosure at least has the following beneficial effects:
the present disclosure provides the multipurpose solid hydrogen storage device, the multipurpose solid hydrogen storage device includes the hydrogen storage device body, the hydrogen storage device body includes the hydrogen storage profiles, the upper cover plates and the lower cover plates, the upper cover plates are arranged at the upper ends of the hydrogen storage profiles, the lower cover plates are arranged at the lower ends of the hydrogen storage profiles, the upper ends and the lower ends of the hydrogen storage profiles are fixed by the upper cover plates and the lower cover plates, and the gas chambers and the heat conduction water chambers are formed in the hydrogen storage profiles; then the gas valves are mounted on the upper cover plates and communicated with the gas chambers, so that hydrogen can be injected into the gas chambers through the gas valves. It is to be understood that solid hydrogen storage materials are arranged in the gas chambers, and the solid hydrogen storage materials can release a large amount of heat when absorbing hydrogen, the water inflow valves and the water outflow valves, which are communicated with the heat conduction water chambers, are further arranged on the upper cover plates, cold water is injected into the heat conduction water chambers through the water inflow valves and the water outflow valves, and heat is taken away through the cold water. Therefore, the solid hydrogen storage materials can continuously and efficiently absorb and store hydrogen, thereby greatly increasing the hydrogen storage capacity of the hydrogen storage device body; and the hydrogen storage device body is also convenient to move and use.

According to the multipurpose solid hydrogen storage device provided by the present disclosure, other advantages, objectives, and features of the present disclosure will be partially reflected through the following description, and partially understood by those skilled in the art through research and practice of the present disclosure.

### BRIEF DESCRIPTION OF DRAWINGS

The drawings are used for providing further understandings of the present disclosure, constitute a part of the specification and explain the present disclosure in conjunction with embodiments of the present disclosure, and do not constitute any limitation to the present disclosure. In the drawings:

FIG. 1 is a schematic structural diagram according to the present disclosure.

FIG. 2 is a schematic diagram illustrating an internal structure of a hydrogen storage profile in the present disclosure.

FIG. 3 is a structural bottom view of an upper cover plate in the present disclosure.

FIG. 4 is a schematic diagram illustrating an internal structure of an upper cover plate in the present disclosure.

FIG. 5 is a partial schematic structural diagram of a hydrogen storage profile in the present disclosure.

FIG. 6 is a schematic structural diagram of a lower cover plate in the present disclosure.

FIG. 7 is a schematic structural diagram of a fixed hydrogen storage seat in the present disclosure.

FIG. 8 is a schematic diagram illustrating an internal structure of a fixed hydrogen storage seat in the present disclosure.

FIG. 9 is an exploded schematic structural diagram of an anti-bending module in the present disclosure.

FIG. 10 is a schematic structural diagram of an anti-bending module in the present disclosure.

FIG. 11 is a first partial schematic structural diagram of a centralizing mechanism in the present disclosure.

FIG. 12 is a second partial schematic structural diagram of a centralizing mechanism in the present disclosure.

FIG. 13 is a schematic structural diagram of a first C-type centralizing plate in the present disclosure.

FIG. 14 is a schematic diagram illustrating an internal structure of a telescopic lock core component in the present disclosure.

FIG. 15 is a flowchart illustrating engagement of an anti-bending module in the present disclosure.

### DETAILED DESCRIPTION OF THE EMBODIMENTS

The present disclosure will be further explained in detail with reference to the drawings and embodiments, so that those skilled in the art can implement the present disclosure with reference to the specification.

It is to be understood that terms “provided with”, “include” and “comprise” used here do not exclude the presence or addition of one or more other elements or their combinations.

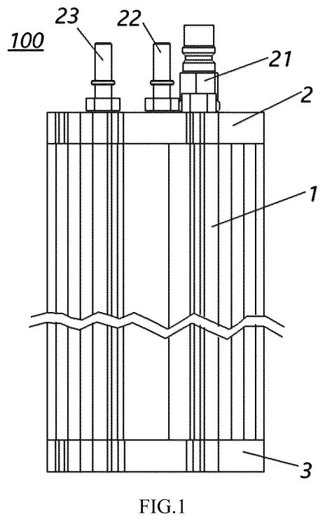

As shown in FIG. 1, the present disclosure provides a multipurpose solid hydrogen storage device, including a hydrogen storage device body 100, and the hydrogen storage device body 100 includes hydrogen storage profiles 1, upper cover plates 2 and lower cover plates 3; specifically, the upper cover plates 2 are arranged at upper ends of the hydrogen storage profiles 1, the lower cover plates 3 are arranged at lower ends of the hydrogen storage profiles, the upper ends and the lower ends of the hydrogen storage profiles 1 are fixed by the upper cover plates 2 and the lower cover plates 3, and gas chambers 11 and heat conduction water chambers 12 are formed in the hydrogen storage profiles 1; then the upper cover plates 2 are provided with gas holes 20, gas valves 21 are mounted on the gas holes 20 and communicated with the gas chambers 11, so that hydrogen can be injected into the gas chambers 11 through the gas valves 21; it is to be understood that solid hydrogen storage materials are arranged in the gas chambers 11, and the solid hydrogen storage materials can release a large amount of heat when absorbing hydrogen, water inflow valves 22 and water outflow valves 23 are further arranged on the upper cover plates 2 and communicated with the heat conduction water chambers 12, cold water is injected into the heat conduction water chambers 12 through the water inflow valves 22 and the water outflow valves 23, and heat is taken away through the cold water. Therefore, the solid hydrogen storage materials can continuously and efficiently absorb and store hydrogen, thereby greatly increasing the hydrogen storage capacity of the hydrogen storage device body 100; and the hydrogen storage device body 100 is also convenient to move and use.

Furthermore, in some embodiments of the present disclosure, the above heat conduction water chamber 12 is located in a middle of an interior of the hydrogen storage profile 1, such that the heat conduction water chamber 12 is located in a middle of the gas chamber 11. An inner water guide pipe 13 is mounted in the heat conduction water chamber 12. Correspondingly, a water inlet 24 and a water outflow channel 25 are formed in the upper cover plate 2, the water inlet 24 is located in a middle of the upper cover plate 2 and located above the heat conduction water chamber 12, the water inflow valve 22 is arranged on the water inlet 24 and connected with an upper end of the inner water guide pipe 13, and the water outflow channel 25 is located in one side of the water inlet 24. Therefore, after being injected through the water inflow valve 22, cold water enters the inner water guide pipe 13 through the water inlet 24, the inner water guide pipe 13 extends downwards all the time to a bottom of the heat conduction water chamber 12, and accordingly, the cold water flows upwards from the bottom of the heat conduction water chamber 12, and then flows out through the water outflow channel 25 to take away heat.

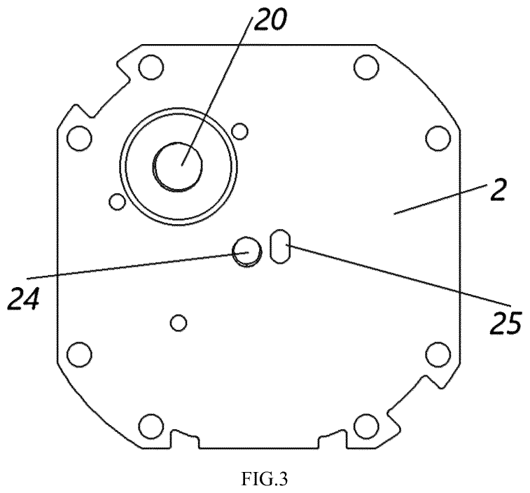

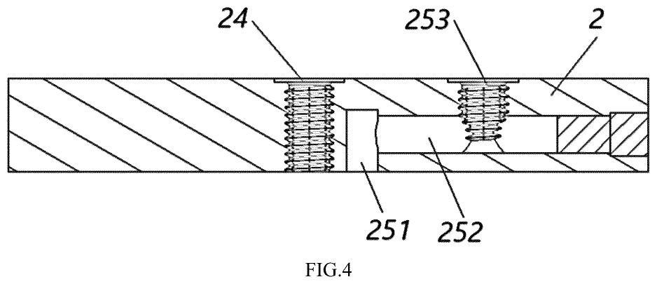

As shown in FIG. 3 and FIG. 4, furthermore, in some embodiments of the present disclosure, a specific structure of the above water outflow channel 25 is provided. Here, the water outflow channel 25 of this structure includes a first water outlet 251, a middle water outflow groove 252 and a second water outlet 253, where the first water outlet 251 is located in one side of the water inlet 24, the middle water outflow groove 252 is located in the upper cover plate 2, the second water outlet 253 is located in an upper surface of the upper cover plate 2, and the water outflow valve 23 is mounted on the second water outlet 253. Therefore, the cold water enters the middle water outflow groove 252 through the above first water outlet 251 after taking away heat, and then enters the second water outlet 253 and the water outflow valve 23. Heat is taken away by the cold water, such that solid hydrogen storage materials can continuously and efficiently absorb and store hydrogen, thereby greatly increasing the hydrogen storage capacity of the hydrogen storage device body 100. The hydrogen storage device body 100 is also convenient to move and use.

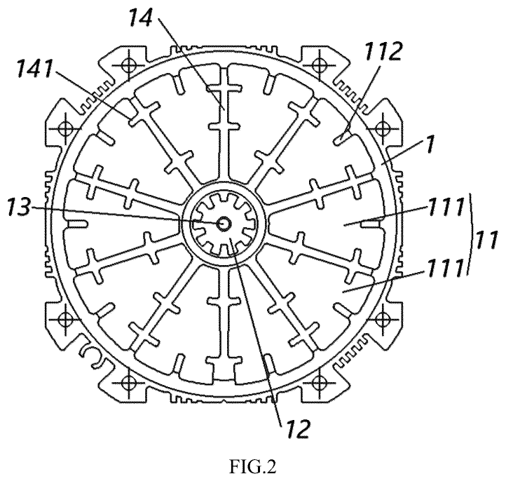

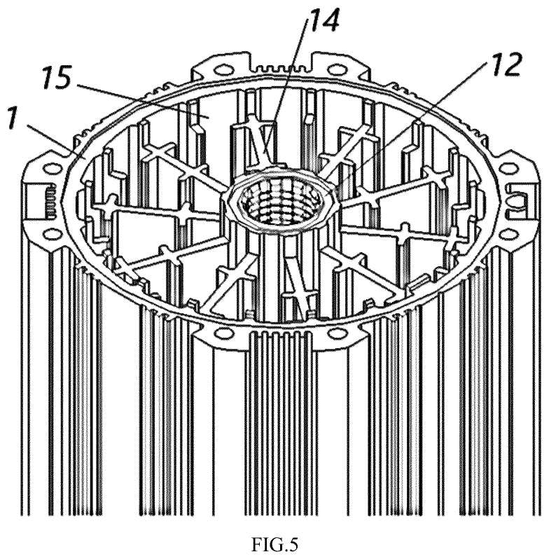

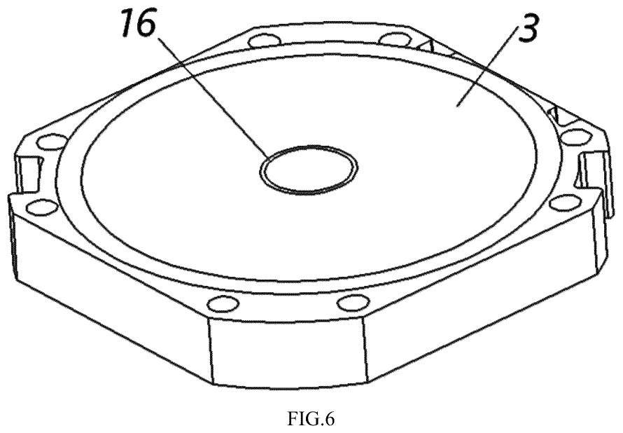

As shown in FIG. 2, FIG. 5 and FIG. 6, furthermore, in some embodiments of the present disclosure, a plurality of heat conduction partitions 14 are arranged between the above gas chamber 11 and the above heat conduction water chamber 12, then the plurality of heat conduction partitions 14 divide the gas chamber 11 into a plurality of sub gas chambers 111, the solid hydrogen storage material is arranged in each sub gas chamber 111, and gas chamber channels 15 are formed between the heat conduction partitions 14 and the upper cover plate 2. Therefore, after being injected through the gas valve 21 on the upper cover plate 2, hydrogen enters the plurality of sub gas chambers 111 through the gas chamber channels 15, and then the solid hydrogen storage materials in the sub gas chambers 111 absorb and store hydrogen. Furthermore, a sealing ring 16 is arranged between the bottom of the heat conduction water chamber 12 and the lower cover plate 3, thereby preventing the situation that the cold water in the heat conduction water chamber 12 enters the sub gas chambers 111 nearby to affect hydrogen storage.

As shown in FIG. 2 and FIG. 5, furthermore, in some embodiments of the present disclosure, a plurality of first heat conduction fins 141 are arranged on a surface of the above heat conduction partition 14, such that heat released after the solid hydrogen storage materials absorb hydrogen is transferred through the plurality of heat conduction partitions 14 and the plurality of first heat conduction fins 141 to be absorbed by the cold water in the heat conduction water chamber 12.

Furthermore, a plurality of second heat conduction fins 112 are mounted on an inner wall of the gas chamber 11, and the second heat conduction fin 112 is located between every two adjacent heat conduction partitions 14, which is conducive to heat transfer.

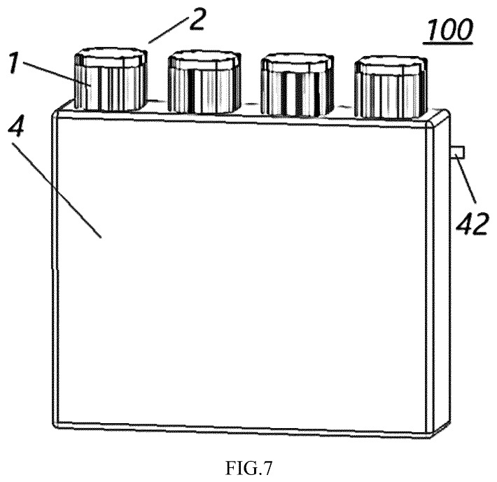

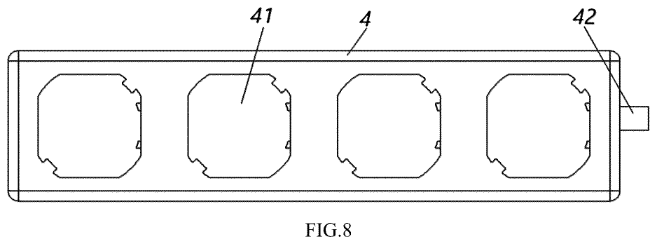

As shown in FIG. 7 and FIG. 8, yet furthermore, a fixed hydrogen storage seat 4 is further arranged in the hydrogen storage device body 100. Here, a plurality of profile holes 41 are formed in the fixed hydrogen storage seat 4, then a plurality of hydrogen storage profiles 1 are mounted in the plurality of profile holes 41, and the plurality of hydrogen storage profiles 1 are convenient to move through the fixed hydrogen storage seat 4. Specifically, the hydrogen storage profiles 1 are invertedly mounted in the fixed hydrogen storage seat 4, thereby improving the safety of the hydrogen storage device body 100, and meanwhile greatly increasing the overall capacity of the hydrogen storage device body 100.

Furthermore, in some embodiments of the present disclosure, a hydrogen channel is further formed in the above fixed hydrogen storage seat 4, the gas valve 21 is communicated with the hydrogen channel, then a side valve body 42 is mounted on a side wall of the fixed hydrogen storage seat 4, and the side valve body 42 is communicated with the hydrogen channel, so that the side valve body 42 can be opened to release hydrogen when hydrogen is needed.

### Exemplary Anti-Bending module

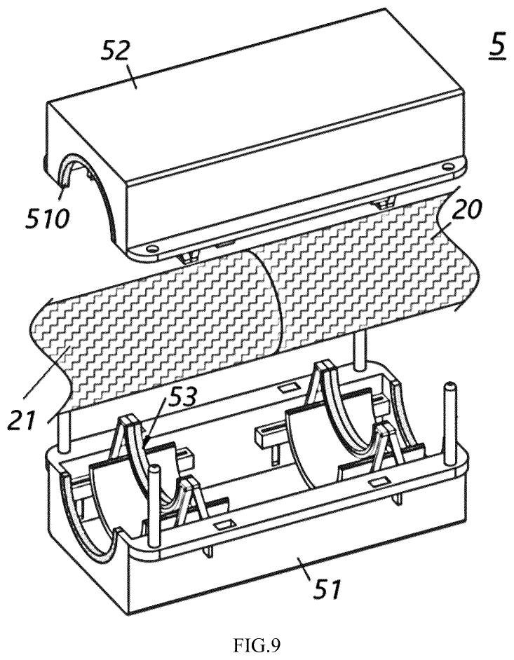

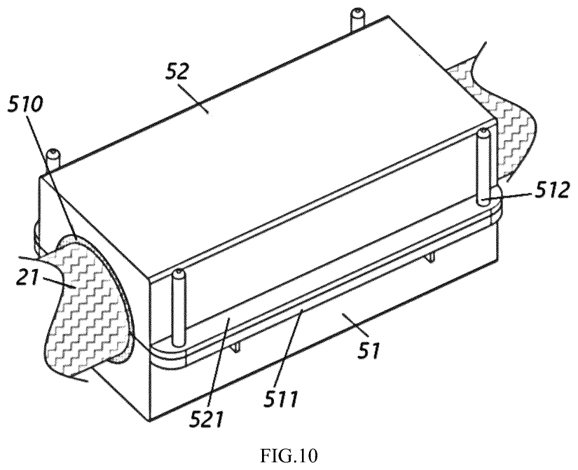

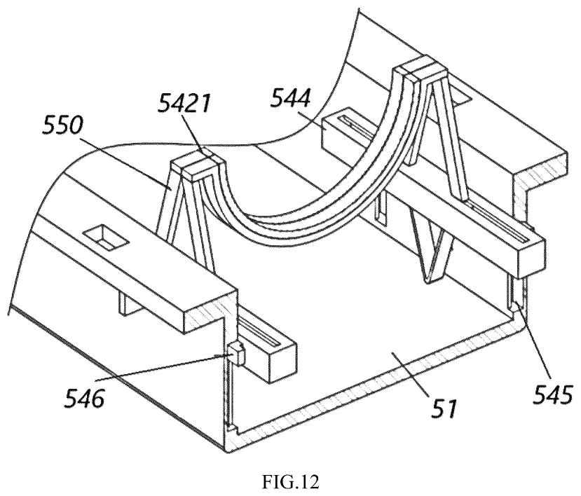

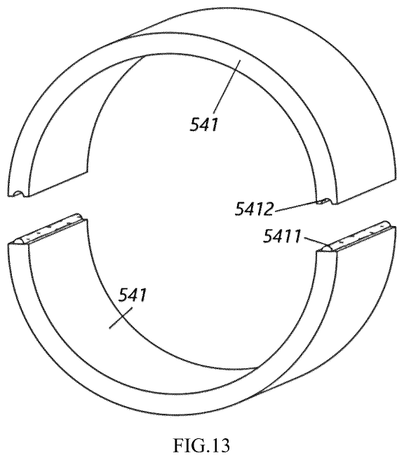

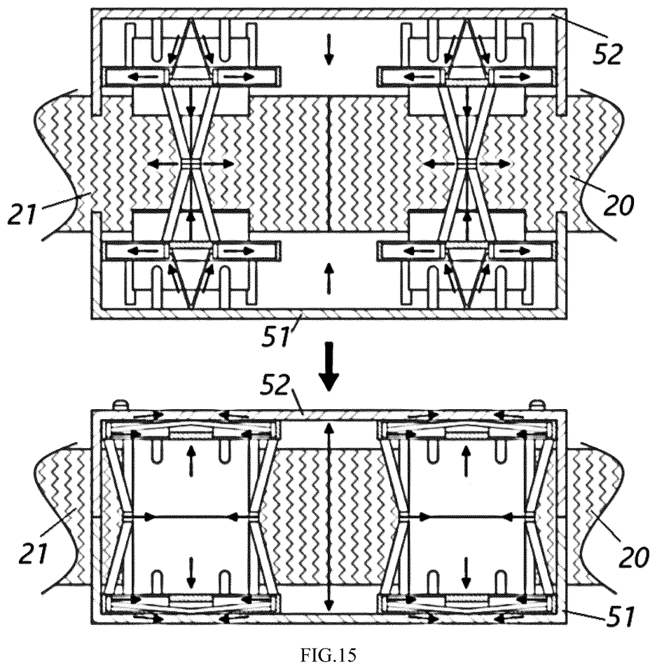

As shown in FIG. 9 to FIG. 15, furthermore, in some embodiments of the present disclosure, the gas valve 21 and the external gas pipe 20 may be connected in a screw joint manner, so that a screw joint needs to be protected, so as to prevent bending at the joint caused by external force compression, leading to hydrogen leakage at the joint between the gas valve 21 and the external gas pipe 20. Therefore, an anti-bending module 5 is mounted between the gas valve 21 and the external gas pipe 20, and the joint between the gas valve 21 and the external gas pipe 20 can be protected through the anti-bending module 5, thereby improving hydrogen safety.

Furthermore, the anti-bending module 5 of the above structure includes a first anti-bending cover 51 and a second anti-bending cover 52. Specifically, the screw joint is shielded by mutually engaging the first anti-bending cover 51 and the second anti-bending cover 52 on the gas valve 21 and the external gas pipe 20. A plurality of centralizing mechanisms 53 are mounted in the first anti-bending cover 51 and the second anti-bending cover 52, and the gas valve 21 and the external gas pipe 20 are fixed internally through the plurality of centralizing mechanisms 53 respectively, so that portions of the gas valve 21 and the external gas pipe 20 in the anti-bending module 5 can be more stable, and the portion of the external gas pipe in the anti-bending module 5 cannot be affected when other portions of the external gas pipe 20 suffer from external force compression.

### Exemplary Centralizing Mechanism

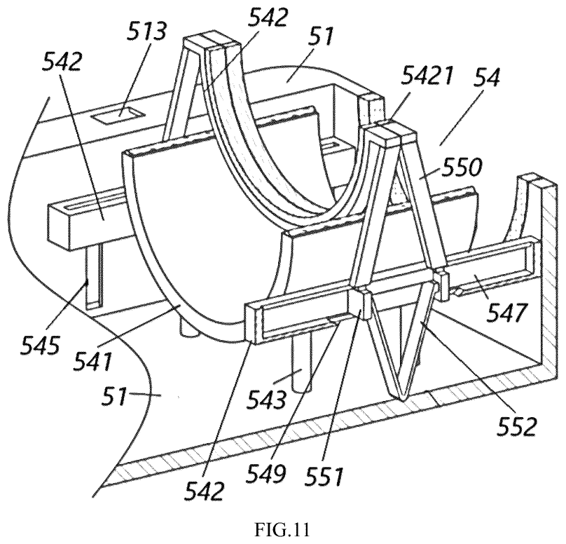

As shown in FIG. 11 to FIG. 13, furthermore, in some embodiments of the present disclosure, a specific structure of the above centralizing mechanism 53 is provided. The centralizing mechanism 53 of this structure includes a first centralizing assembly 54 and a second centralizing assembly, where the first centralizing assembly 54 is mounted in the first anti-bending cover 51, and the second centralizing assembly is mounted in the second anti-bending cover 52. Therefore, after the first anti-bending cover 51 and the second anti-bending cover 52 are mutually engaged, the first centralizing assembly 54 and the second centralizing assembly inside the first anti-bending cover and the second anti-bending cover are mutually engaged accordingly. It is to be understood that their structures are the same.

Specifically, the first centralizing assembly 54 includes a first C-type centralizing plate 541, two second C-type centralizing plates 542 and two centralizing frames. Here, the first C-type centralizing plate 541 is mounted in the first anti-bending cover 51 through a plurality of inner rods 543, and the plurality of inner rods 543 are made of elastic materials, possessing a certain flexible supporting force. Therefore, after the first C-type centralizing plate 541 in the first centralizing assembly 54 and a first C-type centralizing plate 541 in the second centralizing assembly are engaged, the gas valve 21 and the external gas pipe 20 can be better fixed. Furthermore, a protrusion 5411 is arranged at an end of the first C-type centralizing plate 541 in the first centralizing assembly 54, and correspondingly, a groove 5412 is formed in an end of the first C-type centralizing plate 541 in the second centralizing assembly, so that the connection fixity between the two first C-type centralizing plates 541 is improved through the cooperation between the protrusion 5411 and the groove 5412 of the two first C-type centralizing plates 541.

The centralizing frames are further mounted on an inner wall of the first anti-bending cover 51, and the two second C-type centralizing plates 542 are arranged between the two centralizing frames, so that the centralizing frames in the first centralizing assembly 54 and the centralizing frames in the second centralizing assembly move to two sides from an extended state when engaged, and then the two second C-type centralizing plates 542 are mutually engaged to fix the gas valve 21 and the external gas pipe 20.

### Exemplary Centralizing Frame

Furthermore, in some embodiments of the present disclosure, a specific structure of the above centralizing frame is provided. The centralizing frame of this structure includes a guide rail seat 544. Specifically, the guide rail seat 544 and two guide rail grooves 545 are arranged on the inner wall of the first anti-bending cover 51, where the guide rail seat 544 is connected with the guide rail grooves 545 through T-shaped blocks 546, an inner guide groove 547 is mounted in the guide rail seat 544, and two first strip-shaped grooves 548 and a second strip-shaped groove 549 which are communicated with the inner guide groove 547 are respectively formed in the guide rail seat 544. Furthermore, inclined guide rods 550 are mounted in the first strip-shaped grooves 548, then inner ends of the inclined guide rods 550 are connected with inner block bodies 551 in the inner guide groove 547, a pointed torsional spring plate 552 is further mounted between the two inner block bodies 551, and the pointed torsional spring plate 552 can penetrate through the second strip-shaped block 549 to extend out of the guide rail seat 544. The two inner block bodies 551 are expanded through the pointed torsional spring plate 552, so that outer ends of the two inclined guide rods 550 get close to each other, and the above second C-type centralizing plates 542 are mounted between the outer ends of the two inclined guide rods 550 on two sides of the first C-type centralizing plate 541.

Therefore, when the first anti-bending cover 51 and the second anti-bending cover 52 are mutually engaged, the centralizing frames in the first centralizing assembly 54 and the centralizing frames in the second centralizing assembly are firstly mutually engaged, the two second C-type centralizing plates 542 are in butt joint, then the inclined guide rods 550 are stressed to move outwards along the first strip-shaped grooves 548, then the two inclined guide rods 550 get away from each other, then the inclined guide rods 550 move to outermost ends of the first strip-shaped grooves 548, the pointed torsional spring plate 552 is pulled by the two inclined guide rods 550 to retract into the second strip-shaped groove 549, and finally, the second C-type centralizing plates 542 are moved to an outer end of the first C-type centralizing plate 541 by the inclined guide rods 550, so as to fix the gas valve 21 and the external gas pipe 20. First inner cushions 5421 are further mounted on inner walls of the second C-type centralizing plates 542, second inner cushions 510 are also mounted in end grooves of the first anti-bending cover 51 and the second anti-bending cover 52, and the gas valve 21 and the external gas pipe 20 can be conveniently fixed by the first inner cushions 5421 and the second inner cushions 510.

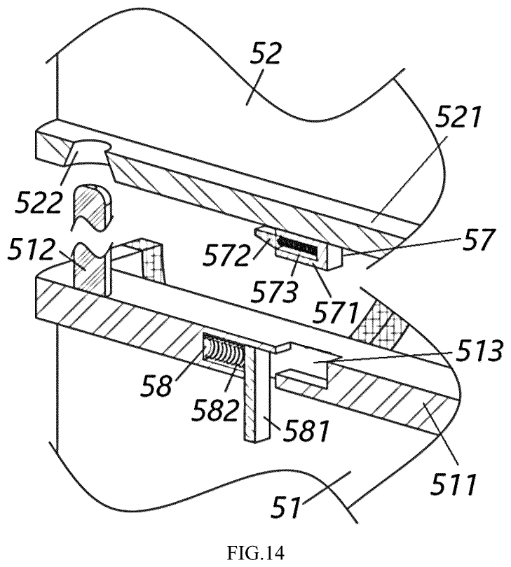

As shown in FIG. 14, furthermore, two first side finned plates 511 are mounted on the first anti-bending cover 51, two second side finned plates 521 are mounted on the second anti-bending cover 52, and the first side finned plates 511 and the second side finned plates 521 are connected through a plurality of latch mechanisms 56, enabling rapid and efficient fixation of, the first side finned plates 511 and the second side finned plates 521 by the plurality of latch mechanisms 56 while also permitting convenient subsequent detachment. Specifically, the latch mechanism 56 of the above structure includes a telescopic lock core component 57 and an unlocking component 58, where latch grooves 513 are formed in the first side finned plates 511, the unlocking components 58 are mounted in the latch groves 513, and the telescopic lock core components 57 are mounted at bottoms of the second side finned plates 521. Therefore, after the first side finned plates 511 and the second side finned plates 521 are mutually engaged, the telescopic lock core components 57 can be engaged in the latch grooves 513, thereby fixing the first side finned plates 511 and the second side finned plates 521; and then the telescopic lock core components 57 can be unlocked by the unlocking components 58, so that the first side finned plates 511 and the second side finned plates 521 are opened.

### Exemplary Telescopic Lock Core Component

As shown in FIG. 14, furthermore, in some embodiments of the present disclosure, a specific structure of the above telescopic lock core component 57 is provided. The telescopic lock core 57 component of this structure includes a lock core sleeve 571 and a spring bolt block 572. Specifically, here, the lock core sleeves 571 are mounted at the bottoms of the second side finned plates 521, lock core springs 573 are mounted in the lock core sleeves 571, and the spring bolt blocks 572 are connected with the lock core springs 573. Furthermore, the above unlocking component 58 includes an unlocking driving lever 581 and an unlocking spring 582. Specifically, the unlocking springs 582 are mounted in the latch groves 513, and the unlocking driving levers 581 are also mounted in the latch grooves 513 and connected with the unlocking springs 582. Therefore, when the telescopic lock core components 57 enter the latch grooves 513, the spring bolt blocks 572 firstly compress the lock core springs 573, and then retract into the lock core sleeves 571 to enter the latch grooves 513, the unlocking springs 582 pull the unlocking driving levers 581 away from the spring bolt blocks 572, an operator can drive the unlocking driving levers 581 to abut against the spring bolt blocks 572, then the telescopic lock core components 57 are unlocked, and the first side finned plates 511 and the second side finned plates 521 can be conveniently detached.

Yet furthermore, guide rods 512 are mounted on the first side finned plates 511, correspondingly, guide grooves 522 corresponding to the guide rods 512 are formed in the second side finned plates 521, and the guide grooves 522 are conical. Specifically, ends of the guide grooves 522 facing the guide rods 512 are greater than ends of the guide grooves facing away from the guide rods 512, so that when the first anti-bending cover 51 and the second anti-bending cover 52 are mutually engaged, the guide rods 512 penetrate into the guide grooves 522, and the first anti-bending cover and the second anti-bending cover can be better in butt joint when mutually engaged, thereby preventing misalignment that affects the engagement effect.

In the description of the present disclosure, it is to be understood that orientation or position relationships indicated by terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential” and the like are orientation or position relationships shown in the drawings, are adopted not to indicate or imply that indicated devices or sensors must be in specific orientations or structured and operated in specific orientations but only to conveniently describe the present disclosure and simplify description and thus should not be understood as any limitation to the present disclosure.

In the present disclosure, unless otherwise clearly stipulated and defined, the terms “mounting”, “connected”, “connection”, “fixing” and other terms should be understood in a broad sense, for example, it may be a fixed connection or a detachable connection or an integrated connection; it may also be a mechanical connection or an electrical connection or a mutual communication; and it may be directly connected or indirectly connected through an intermediate medium, and it may be an internal communication between two elements or the interaction relationship between two elements, unless otherwise clearly defined. For those ordinarily skilled in the art, the specific meaning of the above terms in the present disclosure can be understood according to specific circumstances.

Although the implementation solutions of the present disclosure have been disclosed above, they are not intended to limit applications listed in the specification and implementations, which can be suitable for various fields for the present disclosure. For those skilled in the art, any additional amendment can be made easily. Therefore, the present disclosure is not limited to specific details and legends as shown and described here, without departing from common concepts limited by the claims and the equivalents.

What is claimed is:

1. A multipurpose solid hydrogen storage device, comprising:
a hydrogen storage device body (100), wherein the hydrogen storage device body (100) comprises hydrogen storage profiles (1), upper cover plates (2) and lower cover plates (3), the upper cover plates (2) are arranged at upper ends of the hydrogen storage profiles (1), the lower cover plates (3) are arranged at lower ends of the hydrogen storage profiles, gas chambers (11) and heat conduction water chambers (12) are formed in the hydrogen storage profiles (1), the upper cover plates (2) are provided with gas valves (21) communicated with the gas chambers (11), water inflow valves (22) and water outflow valves (23), and the water inflow valves and the water outflow valves are communicated with the heat conduction water chambers (12).

2. The multipurpose solid hydrogen storage device according to claim 1, wherein the heat conduction water chamber (12) is formed in a middle of the gas chamber (11), an inner water guide pipe (13) is arranged in the heat conduction water chamber (12), a water inlet (24) and a water outflow channel (25) are formed in the upper cover plate (2), the water inlet (24) is located in a middle of the upper cover plate (2) and located above the heat conduction water chamber (12), the water inflow valve (22) is arranged on the water inlet (24) and connected with an upper end of the inner water guide pipe (13), and the water outflow channel (25) is located in one side of the water inlet (24).

3. The multipurpose solid hydrogen storage device according to claim 2, wherein the water outflow channel (25) comprises a first water outlet (251), a middle water outflow groove (252) and a second water outlet (253), the first water outlet (251) is located in one side of the water inlet (24), the middle water outflow groove (252) is located in the upper cover plate (2), the second water outlet (253) is located in an upper surface of the upper cover plate (2), and the water outflow valve (23) is arranged on the second water outlet (253).

4. The multipurpose solid hydrogen storage device according to claim 2, wherein a plurality of heat conduction partitions (14) are arranged between the gas chamber (11) and the heat conduction water chamber (12), the plurality of heat conduction partitions (14) divide the gas chamber (11) into a plurality of sub gas chambers (111), gas chamber channels (15) are formed between the heat conduction partitions (14) and the upper cover plate (2), and a sealing ring (16) is arranged between a bottom of the heat conduction water chamber (12) and the lower cover plate (3).

5. The multipurpose solid hydrogen storage device according to claim 4, wherein a plurality of first heat conduction fins (141) are arranged on a surface of the heat conduction partition (14), a plurality of second heat conduction fins (112) are arranged on an inner wall of the gas chamber (11), and the second heat conduction fin (112) is located between every two adjacent heat conduction partitions (14).

6. The multipurpose solid hydrogen storage device according to claim 1, further comprising a fixed hydrogen storage seat (4), wherein a plurality of profile holes (41) are formed in the fixed hydrogen storage seat (4), and the hydrogen storage profiles (1) are invertedly arranged in the profile holes (41).

7. The multipurpose solid hydrogen storage device according to claim 6, wherein a hydrogen channel is formed in the fixed hydrogen storage seat (4), the gas valve (21) is communicated with the hydrogen channel, a side valve body (42) is arranged on a side wall of the fixed hydrogen storage seat (4), and the side valve body (42) is communicated with the hydrogen channel.

8. The multipurpose solid hydrogen storage device according to claim 1, wherein the gas valve (21) is connected with an external gas pipe (20) through an anti-bending module (5), the anti-bending module (5) comprises a first anti-bending cover (51) and a second anti-bending cover (52), the first anti-bending cover (51) and the second anti-bending cover (52) are mutually engaged on the gas valve (21) and the external gas pipe (20), a plurality of centralizing mechanisms (53) are arranged in the first anti-bending cover (51) and the second anti-bending cover (52), and the gas valve (21) and the external gas pipe (20) are fixed by the plurality of centralizing mechanisms (53) respectively.

9. The multipurpose solid hydrogen storage device according to claim 8, wherein the centralizing mechanism (53) comprises a first centralizing assembly (54) and a second centralizing assembly, the first centralizing assembly (54) is arranged in the first anti-bending cover (51), the second centralizing assembly is arranged in the second anti-bending cover (52), the first centralizing assembly (54) comprises a first C-type centralizing plate (541), two second C-type centralizing plates (542) and two centralizing frames, the first C-type centralizing plate (541) is arranged in the first anti-bending cover (51) through a plurality of inner rods (543), the centralizing frames are arranged on an inner wall of the first anti-bending cover (51), and the two second C-type centralizing plates (542) are arranged between the two centralizing frames.
